(19) United States
(12) Patent Application Publication
(10) Pub. No.: US 2026/0084516 A1
(43) Pub. Date: Mar. 26, 2026

(54) SUPPORT STRUCTURE FOR A THERMAL MANAGEMENT MODULE

(71) Applicant: Hanon Systems, Daejeon (KR)

(72) Inventors: Orest Alexandru Dziubinschi, Dearborn, MI (US); Gabriela Dziubinschi, Dearborn, MI (US)

(21) Appl. No.: 19/216,093

(22) Filed: May 22, 2025

Related U.S. Application Data
(60) Provisional application No. 63/698,806, filed on Sep. 25, 2024.

(51) Int. Cl. B60K 11/00

(52) U.S. Cl. CPC B60K 11/00

(57) ABSTRACT

A torsional control element provided on a base structure for supporting a thermal management module of a vehicle is disclosed. The torsion control element is configured to be integrated with and/or coupled to one or more support members of the base structure. The support member and the torsion control element have a generally C-shaped or reflected C-shaped cross-section, which together form a hollow closed rectangular or square tube-like structure. The torsion control element is positioned on the base structure at a specific location that experiences a significant amount of torsional force generated by the vehicle or a compressor of the thermal management module.

### CROSS-REFERENCE TO RELATED APPLICATION

This application claims the benefit of U.S. Provisional Patent Application Ser. No. 63/698,806, filed Sep. 25, 2024, the entirety of which is herein incorporated by reference.

### FIELD

The disclosure relates to a thermal management module, and more particularly to a supporting structure for a thermal management module that provides torsion control.

### BACKGROUND

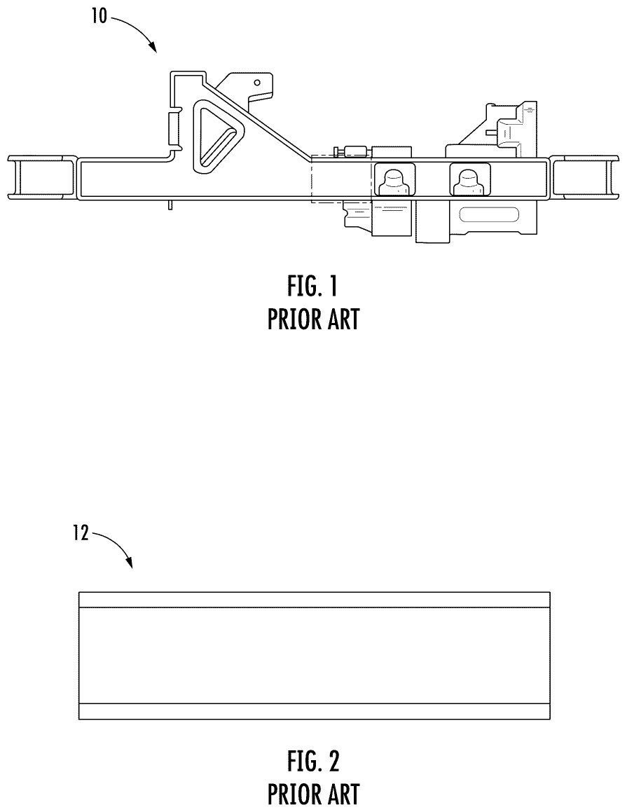

Thermal management modules (TMM) are assemblies typically integrating two sub-assemblies, for example, an integrated refrigerant module (IRM) and an integrated coolant module (ICM). Generally, the IRM is comprises of a compressor, one or more heat exchangers, and valves and the ICM is comprised of one or more coolant pumps, valves, and a distribution plate. Both the IRM and the ICM are typically mounted on a common base or support structure, commonly referred to as a base bracket. Specifically, a compact vehicle thermal management system (CVTMS) is mounted on the support structure within the engine compartment and under an engine hood of the vehicle. A prior art base bracket, as depicted in FIGS. 1-3, typically includes a support member having a generally C-shaped cross-section with an outwardly facing open side.

Forces generated by the vehicle and the compressor subject the CVTMS to loads that lead to displacement and deflections of the CVTMS. However, vehicle manufactures have strict standards and require limiting a relative movement of the TMM to improve on noise, vibration, and harshness (NVH) characteristics of the vehicle as well as durability of the TMM.

Accordingly, it is desirable to develop a support structure for a thermal management module that provides torsion control and minimizes mounting point displacement thereof, while satisfying the NVH and durability requirements of the vehicle manufacturers.

### SUMMARY

In concordance and agreement with the presently described subject matter, a support structure for a thermal management module that provides torsion control and minimizes mounting point displacement thereof, while satisfying the NVH and durability requirements of the vehicle manufacturers, has newly been designed.

In one embodiment, a torsion control element of a support structure for a thermal management module, comprises: a sidewall section; a first leg section extending from an end of the sidewall section; and a second leg section extending from an opposing end of the sidewall, wherein the torsion control element is configured to cooperate with a support member of the support structure to form a generally hollow tube-like structure having a rectangular cross-sectional shape.

In another embodiment, a support structure for a thermal management module, comprises: a support member; and a torsion control element provided with the support member, wherein the torsion control element together with the support member combine to form a generally hollow tube-like structure having a rectangular cross-sectional shape, and wherein the torsion control element is configured to combat a torsional force generated by the thermal management module.

In yet another embodiment, a vehicle, comprises: a thermal management module including a compressor; a support structure configured to support the thermal management module, wherein the support structure comprises: a support member; and a torsion control element provided with the support member, wherein the torsion control element together with the support member combine to form a generally hollow tube-like structure having a rectangular cross-sectional shape; wherein the support structure is configured to combat a torsional force generated by the vehicle and/or the compressor of the thermal management module.

As aspects of some embodiments, the support member has a generally C-shaped cross-section.

As aspects of some embodiments, the torsion control element has a generally C-shaped cross-section.

As aspects of some embodiments, the support member comprises a sidewall section, a first leg section extending from an end of the sidewall section, and a second leg section extending from an opposing end of the sidewall.

As aspects of some embodiments, the torsion control element comprises a sidewall section, a first leg section extending from an end of the sidewall section, and a second leg section extending from an opposing end of the sidewall.

As aspects of some embodiments, the sidewall section and the leg sections of the torsion control element form a generally C-shaped cross-sectional shape.

As aspects of some embodiments, the leg sections of the torsion control element substantially align with leg sections of the support member and faces of the leg sections of the torsion control element abut faces of the leg sections of the support member.

As aspects of some embodiments, the torsion control element is integrally formed with the support member.

As aspects of some embodiments, the torsion control element is welded to the support member.

As aspects of some embodiments, the torsion control element is releasably coupled to the support member.

As aspects of some embodiments, the torsion control element is coupled to the support member by one or more mechanical fasteners.

As aspects of some embodiments, an outer height (H) of the generally hollow tube-like structure is about twice that of an outer width (W) of the generally hollow tube-like structure.

As aspects of some embodiments, the torsion control element is coupled to a portion of the support member that experiences the greatest amount of torsional force.

As aspects of some embodiments, the torsion control element is coupled to a central portion of the support member.

As aspects of some embodiments, the torsion control element is produced from a metal material.

As aspects of some embodiments, a ratio of a length (LTE) of the torsion control element to a length (L) of the support member is greater than about 0.25 and less than about 0.3

As aspects of some embodiments, a ratio of an outer height (H1) of the support member to a length (L) of the support member is greater than about 0.125 and less than about 0.16.

As aspects of some embodiments, the support structure further comprises another support member provided with another torsion control element.

Further areas of applicability will become apparent from the description provided herein. The description and specific examples in this summary are intended for purposes of illustration only and are not intended to limit the scope of the present disclosure.

### BRIEF DESCRIPTION

The drawings described herein are for illustrative purposes only of selected embodiments and not all possible implementations, and are not intended to limit the scope of the present disclosure.

FIG. 1 is a fragmentary side elevational view of a prior art base structure or bracket of a vehicle;

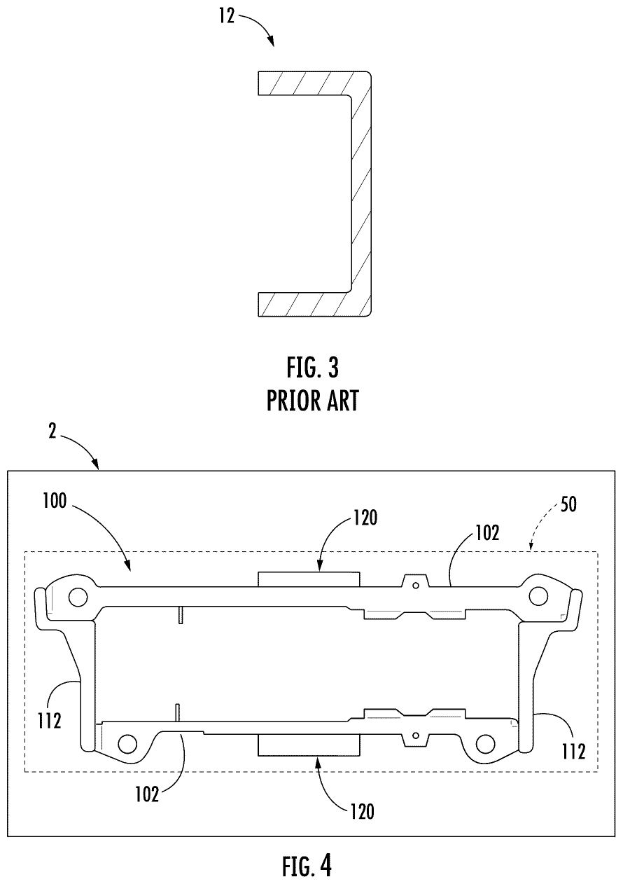

FIG. 2 is an enlarged side elevational view of a portion of a support member of the prior art base bracket shown within a rectangular area of FIG. 1;

FIG. 3 is a cross-sectional view of the support member of the prior art base bracket of FIGS. 1 and 2;

FIG. 4 is a top plan view of a base or support structure for a thermal management module of a vehicle according to an embodiment of the present disclosure;

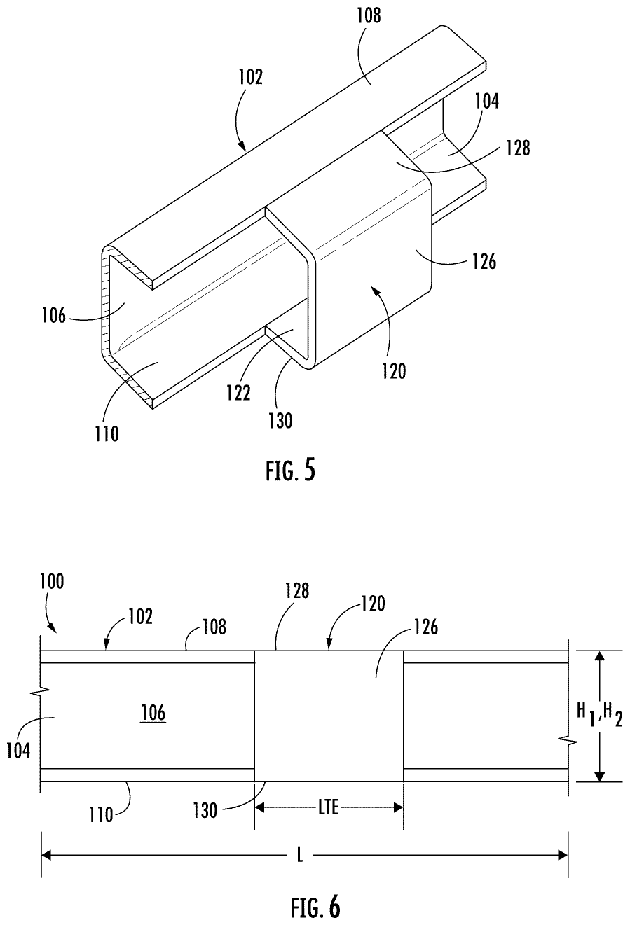

FIG. 5 is a fragmentary perspective view of a portion of the support structure of FIG. 4, showing a torsion control element coupled to a support member;

FIG. 6 is a fragmentary front elevational view of the portion of the support structure of FIG. 5;

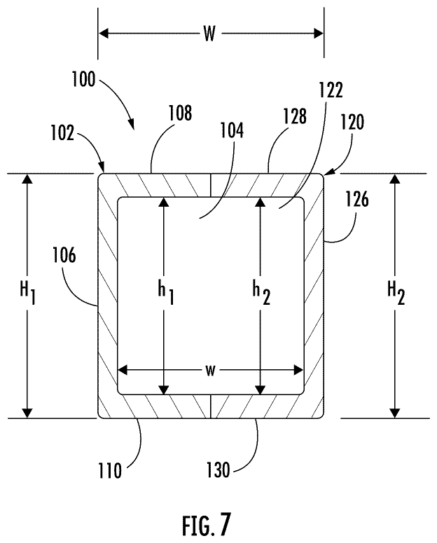

FIG. 7 is a cross-sectional view of the portion of the support structure of FIGS. 4-6, showing the torsion control element coupled to the support member;

FIG. 8 is a cross-sectional view of an I-shaped structure; and

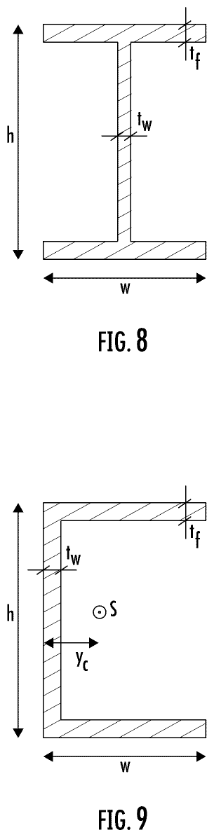

FIG. 9 is a cross-sectional view of a C-shaped structure.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

FIGS. 1-3 depict a prior art base bracket 10 of a vehicle for supporting a thermal management module. As discussed hereinabove, the prior art base bracket 10 typically includes a support member 12 having a generally C-shaped cross-section. However, a lack of stiffness of the support member 12 is a major contributor to the overall torsional behavior of the thermal management module, which leads to undesirable displacements at mounting and support points thereof.

FIGS. 4-7 illustrate a base or support structure 100 incorporated into a vehicle 2 according to an embodiment of the present disclosure. The support structure 100 may be specifically configured to support a thermal management module 50 of the vehicle 2. The support structure 100 comprises one or more support members 102 for providing a framework for supporting the thermal management module 50 of the vehicle 2. In some embodiments, the support structure 100 comprises a pair of spaced apart support members 102. Each of the support member 102 shown has a generally C-shaped cross-section with an outwardly facing open side or channel 104. In a non-limiting example, the one or more C-shaped support members 102 may be formed by a sidewall section 106 extending along a longitudinal axis thereof and a pair of opposing leg sections 108, 110 extending laterally outward from the sidewall section 106 substantially perpendicular to the longitudinal axis. Each of the support members 102 may be coupled to one or more crossmembers 112. For example, each end of the support members 102 may be coupled to a respective end of one of the crossmembers 112 to form a generally rectangular shaped support structure 100. Although the support structure 100 shown is a separate and distinct assembly of the vehicle 2, it is understood that any one of the members 102, 112 or an entirety of the support structure 100 may form part of a frame or chassis of the vehicle 2.

As shown, the support structure 100 further comprises one or more torsion control elements 120. Each of the torsion control elements 120 may be specifically designed to combat and/or counteract a torsional force exerted on a respective one of the support members 102 of the support structure 100. For example, the torsional force generated by the vehicle 2 and/or compressor loads of the thermal management module 50. It should be appreciated that the torsion control elements 120 and/or the support member 102 may be produced from any suitable material or a combination of materials as desired such as a metal material, a non-metal material, a plastic material, and the like, for example. In a non-limiting example, a thickness of the material for the torsion control element 120 and/or the support member 102 is about 120 mm.

The torsion control elements 120 may have a certain size to be coupled to and/or integrate with a specific portion of the support structure 100. In some embodiments, more clearly shown in FIGS. 6 and 7, a length (L), an outer height (H₁), and/or an inner height (h₁) of the one or more support members 102 and/or a length (LTE), an outer height (H₂), and/or an inner height (h₂) of the torsion control element 120 along with an outer width (W) and/or an inner width (w) of the combination thereof may be specifically designed and may be dependent on one another. In a non-limiting example, a ratio of the length (LTE) to the length (L) is greater than about 0.25 and less than about 0.3 (i.e., 0.25<LTE/L<0.3) and a ratio of the heights (H₁, H₂) to the length (L) is greater than about 0.125 and less than about 0.16 (e.g., 0.125<H₁, H₂/L<0.16).

It is understood that in some embodiments one or more of the torsion control elements 120 may be releasably or fixedly coupled to the one or more support member 102. Accordingly, the torsion control elements 120 may be added, repositioned, and/or removed from the one or more support members 102 if desired. In other embodiments, one or more of the torsion control elements 120 may be integrally formed with the one or more support members 102.

In some embodiments, each of the torsion control elements 120 may be releasably or fixedly coupled to and/or integrally formed with a portion of the support member 102 that experiences the greatest amount of torsion resulting from the thermal management module 50. For example, as depicted in FIG. 4, the torsion control element 120 may be coupled to and/or integrated with a central portion of the one or more support members 102. Thus, the torsion control element 120 may target torsion control and increase torsional stiffness at a specific location along the one or more support members 102, which improves an overall structural integrity of the entire support structure 100.

Advantageously, the torsion control element 100 reduces displacement of the thermal management module 50 at isolated mounting and support points on the support structure 100 as well as reduces isolation complexity and structural weight of the support structure 100. Accordingly, the support structure 100 with the one or more torsion control elements 120 is able to satisfy the NVH and durability requirements of the vehicle manufacturers. Other advantages include but are not limited to improving an overall dynamic behavior of the support structure 100 along with achieving a significant manufacturing cost reduction by targeting a critical area of the support structure 100 (i.e., a specific portion of the one or more support members 102) and not the support members 102 and/or the support structure 100 in their entirety.

In preferred embodiments, at least one of the torsion control elements 120 has a generally reflected C-shaped cross-section with an open side or channel 122 facing the open side or channel 104 of the one or more support members 102. It should be appreciated that in the circumstance where the one or more support members 102 has a generally reflected C-shaped cross-section, the torsion control element 120 has a corresponding generally C-shaped cross-section. As best seen in FIG. 7, when the torsion control element 120 is integrated with or coupled to the one or more support members 102, the specific portion of the support structure 100 at which the torsion control element 120 is located has a hollow tube-like structure with a generally closed contour shape. Preferably, a generally square or rectangular cross-sectional shaped structure. The hollow rectangular structure provides a greater area moment of inertia (AMOI) than other conventional shapes, such an I-shaped cross-section shown in FIG. 8 and a C-shaped cross-section shown in FIG. 9. A drawback of the base structures with an I-shaped or C-shaped cross-section is that they mainly address bending and not torsion.

The AMOI of the generally rectangular shaped support structure 100 is calculated using the equations:

$$Strong Axis : {I}_{y} = \frac{W * {H}^{3} - w * {h}^{3}}{12}$$

$$Weak Axis : {I}_{z} = \frac{{W}^{3} * H - {w}^{3} * h}{12}$$

### Example 1

| | | | AMOI (mm\hat{ }4) | |
|---|---|---|---|---|
| H (mm) | 240 | Strong Axis | 4.95E+07 | Bending |
| W (mm) | 120 | Weak Axis | 1.62E+07 | Bending |
| h (mm) | 220 | Polar* | 6.57E+07 | Torsion |
| w (mm) | 100 | *2^{nd} Polar MOI | | |

The AMOI of the generally I-shaped support structure shown in FIG. 8 is calculated using the equations:

$$Strong Axis : {I}_{y} = \frac{{wh}^{3}}{12} - \frac{( w - {t}_{w} ) * {( h - 2 {t}_{w} )}^{3}}{12}$$

$$Weak Axis : {I}_{z} = \frac{{hw}^{3}}{12} - \frac{( w - {t}_{w} ) * ( h - 2 {t}_{w} )}{12}$$

### Example 2

| | | | AMOI (mm\hat{ }4) |
|---|---|---|---|
| h (mm) | 240 | Strong Axis | 4.06E+07 |
| w (mm) | 120 | Weak Axis | 2.90E+06 |
| t_{w} (mm) | 10 | Polar | 4.35E+07 |
| t_{f} (mm) | 10 | | |

The AMOI of the generally C-shaped support structure shown in FIG. 9 is calculated using the equations:

$$Strong Axis : {I}_{y} = \frac{w * {h}^{3} - ( w * {t}_{w} ) * {( h - 2 {t}_{f} )}^{3}}{12}$$

$$Distance point a to centroid : {y}_{c} = \frac{1}{( h - 2 {t}_{f} ) * {t}_{w} + 2 * w * {t}_{f}} * ( ( h - 2 {t}_{f} ) * {t}_{w} * \frac{{t}_{w}}{2} + 2 * w * {t}_{f} * \frac{w}{2} )$$

$$Moment of Inertia - Weak Axis : {I}_{z} = \frac{( h - 2 * {t}_{f} ) * {t}_{w}^{3}}{12} + ( h - 2 * {t}_{f} ) * {t}_{w} * {( {y}_{c} - \frac{{t}_{w}}{2} )}^{2} + \frac{2 * {t}_{f} * {w}^{3}}{12} + 2 * w * {t}_{f} * {( \frac{w}{2} - {y}_{c} )}^{2}$$

### Example 3

| | | | AMOI (mm\hat{ }4) |
|---|---|---|---|
| h (mm) | 240 | Strong Axis | 4.06E+07 |
| w (mm) | 120 | Weak Axis | 6.37E+07 |
| t_{w} (mm) | 10 | Polar | 4.70E+07 |
| t_{f} (mm) | 10 | y_{c} | 33.70 |

Thus, the generally rectangular shaped support structure 100 provides improved torsion control over the I-shaped and C-shaped structures. Unlike the prior art base structures or brackets, the support structure 100 with the increased AMOI can combat and/or counteract the torsional forces generated by and transmitted from the vehicle 2 and the compressor loads of the thermal management module 50.

Referring back to FIGS. 4-7, the exemplary C-shaped torsion control element 120 may be formed by a sidewall section 126 extending along a longitudinal axis thereof and a pair of opposing leg sections 128, 130 extending laterally outward from the sidewall section 126 substantially perpendicular to the longitudinal axis of the torsion control element 120. A distance or the inner height (h₂) between the leg section 128, 130 of the torsion control element 120 may be substantially similar or the same as a distance or the inner height (h₁) between the leg sections 108, 110 of the specific portion of one or more support members 102. Likewise, the outer height (H₂) of the torsion control element 120 may be substantially similar or the same as the outer height (H₁) of the one or more support members 102. Accordingly, when the torsion control element 120 is integrated with or coupled to the one or more support members 120, each of the leg sections 128, 130 of the torsion control element 120 are substantially aligned with a corresponding one of the leg sections 108, 110 of the one or more support members 102. A face of each of the leg sections 128, 130 of the torsion control element 120 abuts a face of the corresponding one of the leg sections 108, 110 of the one or more support members 102.

Various means and methods may be employed to integrate and/or couple the torsion control element 120 to the one or more support members 102. In some embodiments, the torsion control element 120 may be integrated with and/or coupled to the one or more support members 102 by a welding process. In some instances, a weld seam may be formed along a juncture where the faces of the leg sections 128, 130 abut the corresponding faces of the leg sections 108, 110. In other embodiments, the torsion control element 120 may be integrated with and/or coupled to the one or more support members 102 by mechanical means such as fasteners, tabs, clips, and the like. It should be understood that any suitable means and method may be employed as desired. It should also be understood that the torsion control element 120 may be integrally formed with the one or more support members 102 as a unitary structure if desired.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A torsion control element of a support structure for a thermal management module, comprising:
a sidewall section;
a first leg section extending from an end of the sidewall section; and
a second leg section extending from an opposing end of the sidewall, wherein the torsion control element is configured to cooperate with a support member of the support structure to form a generally hollow tube-like structure having a rectangular cross-sectional shape.

2. The torsion control element of claim 1, wherein the sidewall section and the leg sections form a generally C-shaped cross-sectional shape.

3. A support structure for a thermal management module, comprising:
a support member; and
a torsion control element provided with the support member, wherein the torsion control element together with the support member combine to form a generally hollow tube-like structure having a rectangular cross-sectional shape, and wherein the torsion control element is configured to combat a torsional force generated by the thermal management module.

4. The support structure of claim 3, wherein the support member has a generally C-shaped cross-section.

5. The support structure of claim 3, wherein the torsion control element has a generally C-shaped cross-section.

6. The support structure of claim 3, wherein the support member comprises a sidewall section, a first leg section extending from an end of the sidewall section, and a second leg section extending from an opposing end of the sidewall.

7. The support structure of claim 3, wherein the torsion control element comprises a sidewall section, a first leg section extending from an end of the sidewall section, and a second leg section extending from an opposing end of the sidewall.

8. The support structure of claim 7, wherein the leg sections of the torsion control element substantially align with leg sections of the support member and faces of the leg sections of the torsion control element abut faces of the leg sections of the support member.

9. The support structure of claim 3, wherein the torsion control element is integrally formed with the support member.

10. The support structure of claim 3, wherein the torsion control element is welded to the support member.

11. The support structure of claim 3, wherein the torsion control element is releasably coupled to the support member.

12. The support structure of claim 3, wherein the torsion control element is coupled to the support member by one or more mechanical fasteners.

13. The support structure of claim 3, wherein an outer height (H) of the generally hollow tube-like structure is about twice that of an outer width (W) of the generally hollow tube-like structure.

14. The support structure of claim 3, wherein the torsion control element is coupled to a portion of the support member that experiences the greatest amount of torsional force.

15. The support structure of claim 3, wherein the torsion control element is coupled to a central portion of the support member.

16. The support structure of claim 3, wherein the torsion control element is produced from a metal material.

17. The support structure of claim 3, wherein a ratio of a length (LTE) of the torsion control element to a length (L) of the support member is greater than about 0.25 and less than about 0.3

18. The support structure of claim 3, wherein a ratio of an outer height (H1) of the support member to a length (L) of the support member is greater than about 0.125 and less than about 0.16.

19. The support structure of claim 3, further comprising another support member provided with another torsion control element.

20. A vehicle, comprising:
a thermal management module including a compressor;
a support structure configured to support the thermal management module, wherein the support structure comprises:
a support member; and
a torsion control element provided with the support member, wherein the torsion control element together with the support member combine to form a generally hollow tube-like structure having a rectangular cross-sectional shape;
wherein the support structure is configured to combat a torsional force generated by the vehicle and/or the compressor of the thermal management module.
